(19) United States
(12) Patent Application Publication
(10) Pub. No.: US 2003/0125110 A1
(43) Pub. Date: Jul. 3, 2003

(54) Games utilizing electronic display strips and methods of making display strips

(76) Inventors: Timothy J. Lalley, Boise, ID (US); Paul G. Russell, Campbell, CA (US); Alan Engmark, Ft. Collins, CO (US); Craig A. Delagardelle, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/026,894

(22) Filed: Dec. 27, 2001

(51) Int. Cl. A63F 13/00

(52) U.S. Cl. 463/30; 463/47

(57) ABSTRACT

A game includes display strips and a game processor. The game can be played by applying display strips to players. The display strips include a plurality of lights for displaying game information. Players can input information to the game processor, and the game processor can provide output signals to the display strips to enable the strips to display the game information. The game processor can be a hand-held microprocessor capable of executing stored game instructions. The game information can be conveyed in the form of illumination patterns, text, characters, and other images. The display strips can be used in conjunction with another display, which can display detailed or high resolution game information. The visual impact of the game is enhanced because of game information conveyed by the display strips mounted on the players. A method of making a display strip allows for a custom cover to be created by printing a pattern on label stock, and securing the label stock to electronic component stock including an array of lights.

### TECHNICAL FIELD

The technical field is display strips. Specifically, the technical field is games in which display strips can be mounted to individuals for displaying game information.

### BACKGROUND

A typical electronic game includes a display, a game processor, and input devices that allow players to provide input to the game processor. Known electronic games may be unsatisfactory because a conventional display provides a relatively narrow field of view to convey game information. In addition, conventional game displays may convey insufficient game information to players.

### SUMMARY

According to a first embodiment, a game comprises display strips and a game processor. The game can be played by applying display strips to players, wherein the display strips comprise a plurality of lights, and wherein the lights are capable of displaying game information. Players can input information to the game processor, and the game processor can provide output signals to the display strips to enable the strips to display the game information. The game processor can be a hand-held microprocessor capable of executing stored game instructions, or a stand-alone unit. The game information can be conveyed by images such as illumination patterns, text, characters, and other images. The display strips on the players can be used in conjunction with an additional display, which can display more detailed or higher resolution game information. The additional display can be a display of the hand-held microprocessor, or a separate display device.

According to the first aspect, a visual effect of the game is enhanced because of the game information conveyed by the display strips mounted on the players.

According to a second aspect, a display strip mounted on a particular player can convey information regarding that player's status in the game.

According to the second aspect, other players can gain a competitive advantage in the game by viewing opponents' displayed game status. This aspect may require a player to expand his field of view during the game, further enhancing the visual effect of the game.

According to the third aspect, the display strips can also include audio capability. The inclusion of audio capability allows additional game information to be conveyed by the display strips.

According to a fourth aspect, a method of making a display strip comprises providing display component stock comprising a plurality of lights and other circuitry, providing label stock having a printable surface, providing a source of electronic instructions, printing a pattern on the label stock, and securing the label stock to the electronic component stock. A user can create a custom pattern for printing on the label stock using the electronic instructions. The label stock serves as a cover for the electronic component stock.

According to the fourth aspect, display strips can be made having covers with custom patterns. The display strips can be used in games, for ornamentation, and for other purposes.

Other aspects and advantages will become apparent from the following detailed description, taken in conjunction with the accompanying figures.

### DESCRIPTION OF THE DRAWINGS

The detailed description will refer to the following drawings, wherein like numerals refer to like elements, and wherein:

FIG. 1A is a plan view of a display strip according to a first embodiment;

FIG. 1B is a plan view of a display strip according to a second embodiment;

FIG. 1C is a plan view of a display strip according to a third embodiment;

FIG. 1D is a plan view of a display strip according to a fourth embodiment;

FIG. 2 illustrates a first embodiment of a game having a display strip;

FIG. 3 illustrates a second embodiment of a game having display strips;

FIG. 4 is a front view of a player equipped with an embodiment of a combat simulation game using display strips;

FIG. 5 is a rear view of the player equipped with the combat simulation game illustrated in FIG. 4;

FIG. 6 is a perspective view of an electrochemical cell used to power a display strip;

FIG. 7 is a plan view of an embodiment of a display strip with a cover of the display strip removed;

FIG. 8 is a side view of the display strip illustrated in FIG. 7; and

FIGS. 9-12 illustrate a method of making display strips.

### DETAILED DESCRIPTION

Games having display strips will be discussed by way of preferred embodiments and by way of the figures.

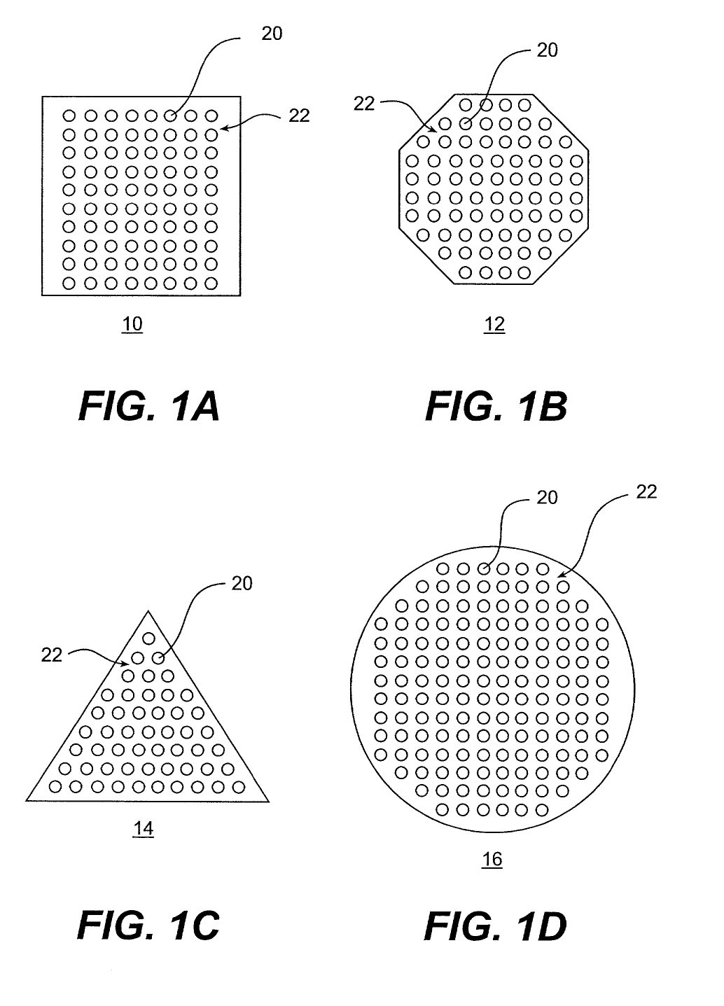

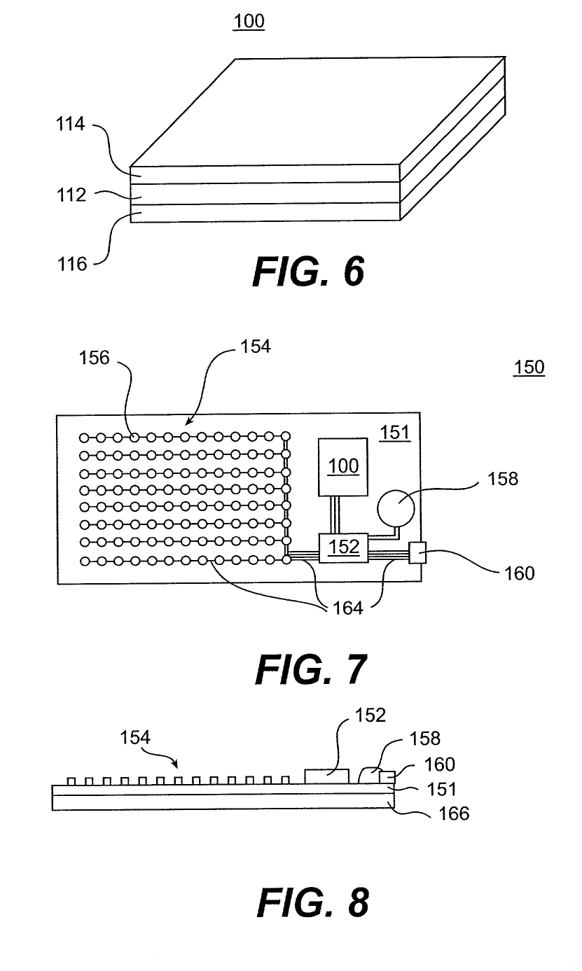

FIGS. 1A, 1B, 1C and 1D are plan views of embodiments of display strips 10, 12, 14, 16, respectively, for displaying game information. The display strips 10, 12, 14, 16 can include an electrochemical power source, an array of lights, audio sources, and other electronic components. The lights are indicated by reference numeral 20 in FIGS. 1A-1D. The other electronic components of the display strips 10, 12, 14, 16 are not illustrated in FIGS. 1A-1D, and are discussed in detail with reference to FIGS. 6-8.

The display strips 10, 12, 14, 16 are capable of displaying game information, and include a mounting structure (illustrated in FIG. 8) that allows the strips 10, 12, 14, 16 to be mounted on a player for the purpose of displaying the game information on the player. The strips 10, 12, 14, 16 can be mounted to a player's skin or clothing, or to any other mounting surface on an individual. The display strips 10, 12, 14, 16 can be flexible and can generally conform to a surface or contour of the body of a player.

The lights 20 can comprise, for example, patterns of white and/or colored lights 20. The patterns of lights 20 can be arranged as an array 22 so that textual information, patterns, characters, and other images can be displayed to convey game information. The electrochemical power sources in the strips can be self-contained within the strips 10, 12, 14, 16, so that external power devices are not necessary to power the strips 10, 12, 14, 16.

The strips 10, 12, 14, 16 can be coupled to various game processors for displaying game information. Various game embodiments including game processors are discussed in detail below.

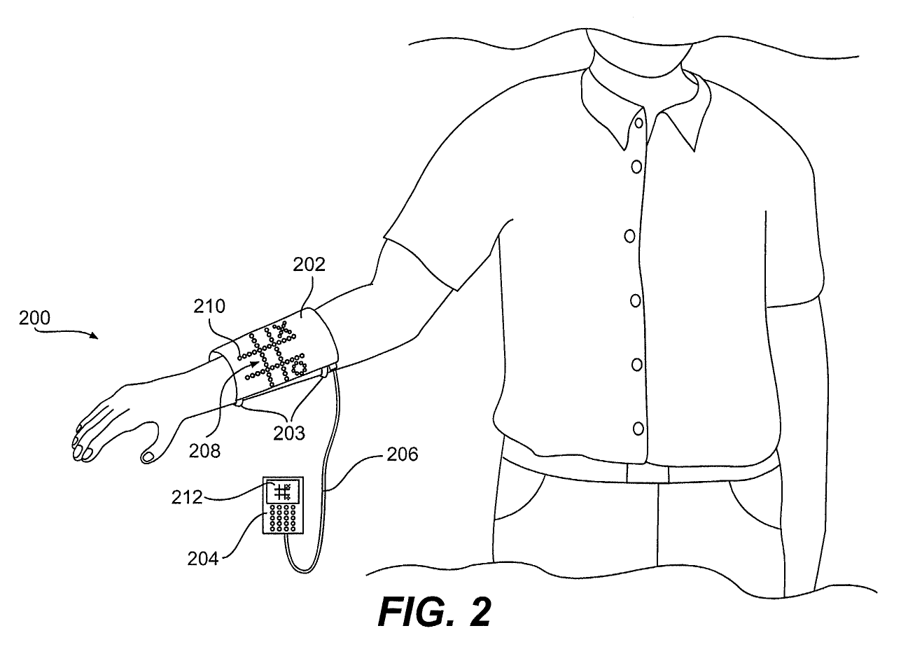

FIG. 2 illustrates an embodiment of a game 200 utilizing a display strip 202 as a display. The display strip 202 is mounted on a player's arm, and is coupled to a game processor 204 by a cable 206. The display strip 202 can be mounted using an adhesive backing (not illustrated), or straps 203. If the display strip 202 will be attached to clothing, the display strip can include a hook and loop mounting structure. The game processor 204 can be, for example, a hand-held microprocessor capable of executing stored game instructions. The game processor 204 need not be devoted specifically to playing electronic games. For example, the game processor 204 could be a device such as a personal data assistant (PDA) which is capable of performing functions unrelated to games.

The display strip 202 can be used to display game information from the game processor 204. In the embodiment illustrated in FIG. 2, the display strip 202 illustrates a tic-tac-toe game played on the game processor 204. The strip 202 can include, for example, an n×n array of lights 210, so that a variety of images 208 can be displayed. In FIG. 2, only illuminated lights 210 are illustrated. The strip 202 can generally be used to display images that would normally be displayed on a display 212 of the game processor 204. Alternatively, the strip 202 can display images intended to complement or supplement the game information displayed on the display 212. Examples of supplemental game information could include a running tally of each player's victories, characters or text displayed to announce a victory, and other images.

The image 208 displayed in FIG. 2 is of relatively low resolution. A greater number of lights 210 can be included in the display strip 202, however, to allow relatively high resolution images to be displayed by the strip 202.

The display strip 202 can also include an audio capability. The audio capability allows the game 200 to convey audible game information to players.

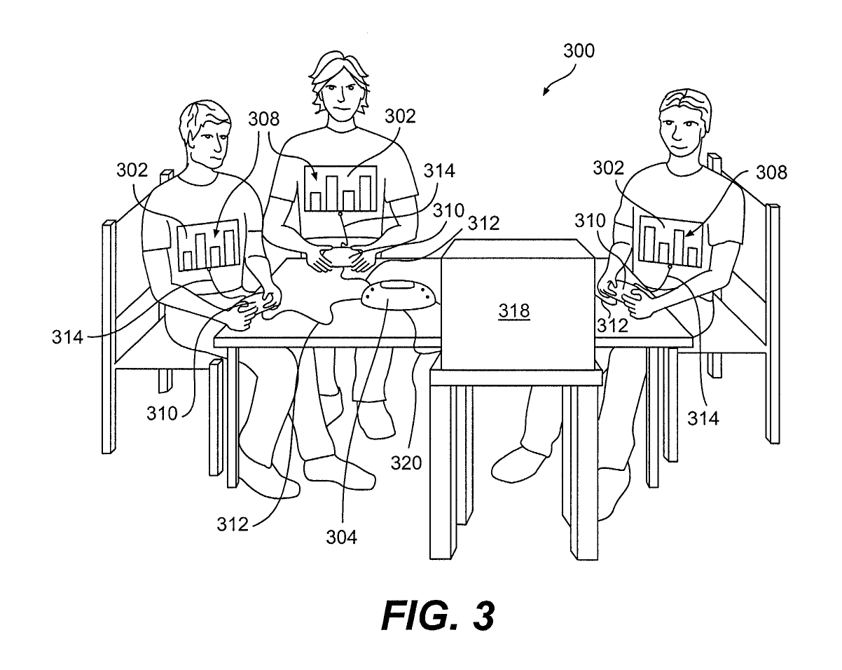

FIG. 3 illustrates an alternative embodiment of a game 300 having display strips 302. The game 300 includes the strips 302 coupled to a game processor 304 by cables 312 and 314. The strips 302 each include an array of lights used to display images 308 in accordance with instructions output from the game processor 304. The individual lights in the display strips 302 are not illustrated.

The game 300 can be played by a plurality of players, with the display strips 302 mounted on the players. The players can input information to the game processor 304 by hand-held input devices 310, which are coupled to the game processor 304 by the cables 312, and to the display strips by the cables 314. Each display strip 302 is associated with a particular input device 310, both of which are to be used by a particular player. The display strips 302 can be coupled to the game processor 304 directly, or through the input devices 310. The game processor 304 can be coupled to a display 318 by a cable 320, and the display 318 can display game information in accordance with instructions output by the game processor 304. The display 318 can be a device such as, for example, a video monitor, a television, or any other display device capable of displaying relatively high resolution, detailed game information.

In the game 300, the images 308 displayed on the display strips 302 can serve to supplement or augment the game information displayed on the display 318. For example, if the game processor 304 executes instructions for a combat game, the display 318 can display the actual combat action, and the display strips 302 can display information indicative of a player's status in the game 300. The player status information can include data such as remaining life force, ammunition remaining in a player's weapon, player speed, time information, particular player skills or other physical attributes, and other information relating the game program being executed. The display strips 302 could also include a visual and/or audio indication of when a player is attacked by a weapon or other device in the game. For example, the display strip 302 of a player struck by a projectile in the combat game could flash a predetermined image and provide an audio indication of the type of attack, the player's status after the attack, and other information. In FIG. 3, the player status information is displayed as several bar charts. However, any form of display image can be used to display game information on the display strips 302.

The player status information displayed on each of the display strips 302 serves to supplement and/or augment the information from the display 318, by presenting additional information outside of the field of view of the display 318. This feature may require a player to occasionally monitor his fellow players' status by observing his opponents' display strips 302. The requirement to monitor fellow players enhances the visual effect of the game 300.

Examples of alternative games executed by the game processor 304 could be race games, where each player's speed, fuel, and other vehicle status and performance data can be displayed by the display strip 302 mounted on the player. A player could therefore gain a competitive advantage by monitoring a fellow player's status and basing game decisions on the status information. Another example of a game could be a trivia or educational game, where a player's score, rank, and other information could be displayed on his display strip 302.

As in the display strip 202, the strips 302 can be mounted to players using mounting structures such as, for example, adhesives, hook and loop fasteners, straps, and other mounting structures. The display strips 302 can be flexible so as to conform to a surface of a player.

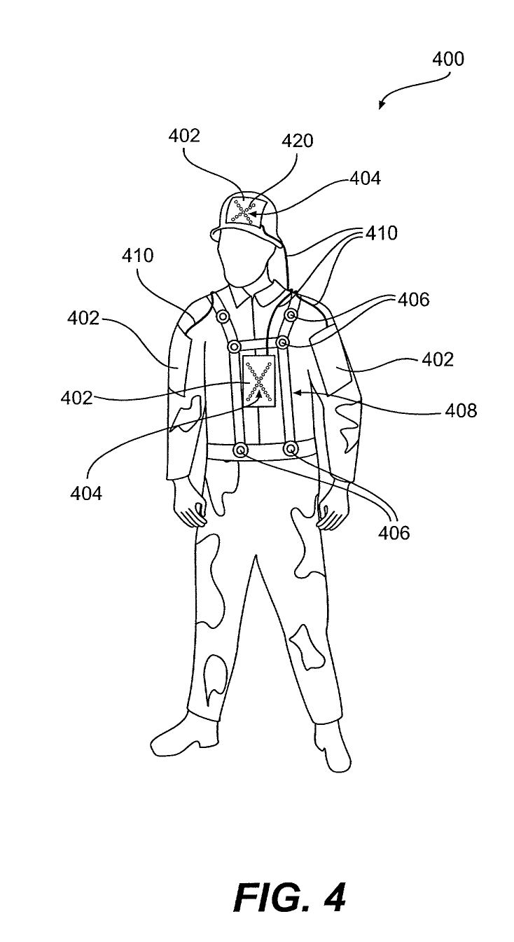

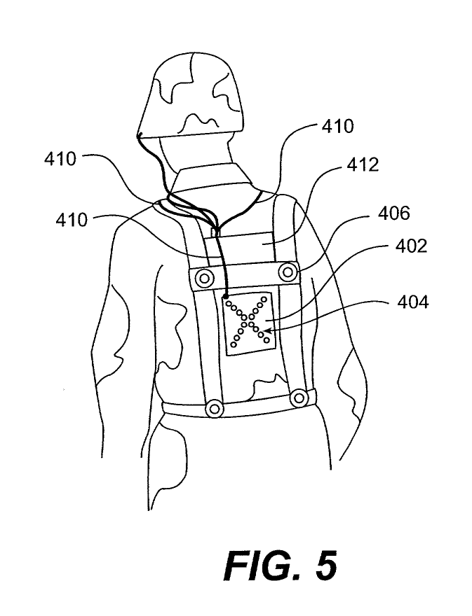

FIG. 4 is a front view of a player equipped with an embodiment of a combat simulation game 400 having display strips 402. FIG. 5 is a rear view of the player illustrated in FIG. 4. The combat simulation game 400 can be used for entertainment purposes, or for training individuals in combat skills. If the simulation game is used for combat training, the player illustrated in FIGS. 4 and 5 can be considered a “trainee” as well as a “player.”

The combat simulation game 400 includes display strips 402 for displaying game information. The game information can comprise, for example, player status information. The display strips 402 can include, for example, an n×n array of lights 420 for indicating player status, such as combat hit locations. In FIG. 4, only illuminated lights 420 are illustrated. In FIG. 4, two of the strips 402 display images 404 in the form of “X” patterns. The “X” patterns may indicate that the player has been struck by a simulated weapon blast or shot in the general locations of a strip 402. Other types of information, such as, for example, a text listing of a specific injury, can be displayed on the strips 402. Under certain conditions, the strips 402 can also be programmed to list other status information such as “CAPTURED” to indicate a player has been captured, and other statuses such as “FRIENDLY,” “BELLIGERENT,” “INACTIVE,” “NONCOMBATANT,” and other related combat status information.

The combat simulation game 400 may include one or more sensors 406 for sensing simulated weapon shots. The sensors 406 can be sensitive to laser light, radio frequency waves, and to other forms of radiation. The sensors 406 can be similar, for example, to those used in the multiple integrated laser emitter system (MILES) used by the U.S. military. The sensors 406 can be mounted to a harness 408.

Referring to FIGS. 4 and 5, the strips 402 can be coupled to a game processor 412 by cables 410. The sensors 406 can also be coupled to the game processor 412 by cables (not shown). The game processor 412 processes signals from the sensors 406, and outputs instructions to the display strips 402 to indicate a hit, an injury, and other status information. Selected strips 402, according to the instructions of the game processor 412, can then display combat status information using the lights 420. The strips 402 or the processor 412 can also include an audio capability for conveying audible game information.

In the above embodiment, the display strips 402 can be mounted on an individual using, for example, an adhesive backing, hook and loop fasteners, or straps.

FIG. 6 illustrates an electrochemical cell 100. The electrochemical cell 100 can be utilized as a power source in any of the display strips described in this specification. The electrochemical cell 100 comprises a layer 114 of insoluble negative pole, a layer 116 of insoluble positive pole, and a layer 112 of aqueous electrolyte. The negative pole layer 114 includes a mix of a negative active insoluble powder material and an aqueous solution. The positive pole layer 116 includes a mix of a positive active insoluble powder material and an aqueous solution. The negative pole layer 114 and the positive 116 pole layer form a flexible thin layer electrochemical battery cell. The electrolyte layer 112 includes a deliquescent material, an electroactive soluble material for ionic conductivity, and a water soluble polymer for viscosity for joining the electrolyte layer 112 to the pole layers 114 and 116. The electrolyte layer 112 can also include a porous insoluble material. The deliquescent material in the electrolyte layer 112 wets the cell 100. The electrochemical cell 100 may operate according to the principles discussed in U.S. Pat. No. 5,897,522 to Nitzan, the contents of which are hereby incorporated by reference.

Each of the display strips discussed in this specification can include a cover over the lights used to display game information. A cover can include a layer of material with an array of “windows” to allow the lights to shine through the cover. The windows can be apertures in the cover aligned with the lights, or, they can be transparent regions of the cover that allow light to shine through the cover. FIG. 7 is a plan view of a section of a display strip 150 with a cover of the display strip 150 removed. The display strip 150 is a general representation of structure for display strips discussed in this specification.

The display strip 150 includes a substrate 151, a processor 152 for controlling operation of the strip 150, an array 154 of lights 156, an audio source 158, and a connector 160. The components on the substrate 151 are connected to the processor 152 by conductors 164. A power cell 100 as illustrated in FIG. 6 can be included to power operation of the display strip 150.

The substrate 151 can be made from flexible materials such as, for example, plastics, cardboard and other paper products, and other substrate materials. The components on the substrate 151 can be mounted on the substrate 151 by, for example, adhesive. Selected components, including the conductors 164 and the processor 152, can be printed on the substrate 151 using a known process for printing conductive connections. If the processor 152 includes a semiconductor chip, conductors connected to the processor 152 can be printed over the substrate 151.

The lights 156 can be, for example, light emitting diodes (LED), and other known lighting devices, connected by printed conductors 164. The array 154 can be formed using any known method for forming LED arrays. The lights 156 may be connected to enable individual activation of each light 156, so that a variety of game information can be displayed by the display strip 150. A relatively small number of lights 156 are illustrated in FIG. 7. However, any number of lights 156 can be included in the display strip 150, depending on the nature of the images to be displayed by the array 154.

The audio source 158 allows the display strip to convey audible as well as visible game information. The audio source 158 can be, for example, a piezoelectric audio transducer, as is known in the art.

The processor 153 can be connected to a game processor (not shown) by the connector 160. The connector 160 can be a multi-pin connector and may include a number of pins sufficient for the processor 152 to communicate the required visible and audible game information to the display strip 150.

FIG. 8 is a side view of the section of the display strip 150 illustrated in FIG. 7. The display strip 150 includes a mounting structure 166 used to mount the strip 150 on an individual. The mounting structure 166 can comprise an adhesive layer. The adhesive layer can be safe for application to a player's skin, such as an adhesive used in bandages. The mounting structure 166 can also comprise a hook and loop fastener layer. Alternatively, the display strip 150 can include straps, and other suitable mounting devices.

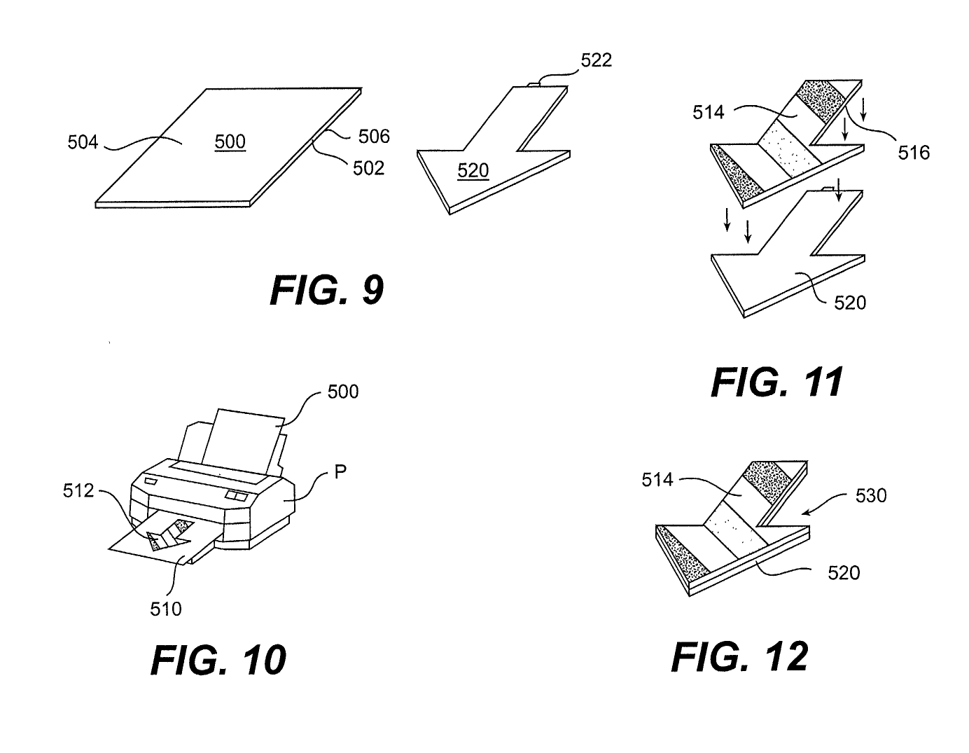

FIGS. 9-12 illustrate a method of making display strips. The method generally involves attaching label stock to display component stock. The label stock can be imprinted with a decorative design, pattern or other image, and serves as the cover for a completed display strip. The method provides for the fabrication of a display strip that can convey game information, and that has a cover having a custom decorative design or pattern. The decorative design on the cover can enhance the effect of the game information conveyed by the strips. Display strips made by the method described below can be used for other purposes, such as, for example, ornamentation of an individual or an object.

Referring to FIG. 9, the process begins with providing a sheet 500 of label stock, a source of electronic instructions (not illustrated), and display component stock 520. The source of electronic instructions can be, for example, an electronic storage medium such as a diskette. The sheet 500 of label stock can have an adhesive backing 502 and a printable surface 504. The printable surface 504 can be made from a sheet of material such as, for example, paper products and transparency materials. The adhesive backing 502 can be covered with a sheet 506 of covering material to prevent the adhesive backing 502 from adhering to unintended objects. The sheet 500 can include a plurality of windows (not illustrated) for allowing lights to shine through, and, if apertures are included, to protrude through the sheet 500. The windows can advantageously be arranged in, for example, an n×n row and column matrix, or in another array form. The display component stock 520 can have any desired shape, and can include lights (not illustrated) spaced so as to conform with the spacing of the n×n row and column matrix in the sheet 500. The display component stock 520 can conform to the embodiment of the display strip 150 illustrated in FIGS. 6-8, and can include control circuitry, a power source, an audio source, and other circuitry.

Referring to FIG. 10, the sheet 500 is loaded into a printer P and the printable surface 504 is printed with an image 512 according to commands from the electronic instructions. The shape of the image pattern 512 can conform to the shape of the display component stock 520. Display component stock can be sold in any shape, and can include an identifier code that the source of electronic instructions will recognize. Prior to printing, the identifier code can be entered into a computer executing the electronic instructions and operating the printer P. The computer then displays the shape of the display component stock. The electronic instructions can be programmed such that a user can use the computer to fill in the shape of the display component stock with images comprising patterns of colors, lines, text, shapes, and other custom devices. The user then instructs the computer to print the custom pattern 512 on the sheet 500 of label stock. A color printer P is preferable so that a wide variety of decorative patterns can be printed on the label stock. The source of electronic instructions can include, for example, a graphics program to facilitate creation of the image, or, existing graphics programs can be accessed when using the electronic instructions. The source of electronic instructions can be written to recognize a large number of identifier codes so that custom label stock covers can be generated for a large number of different display component stock shapes.

Referring to FIG. 11, after printing the pattern 512, the edges around the pattern 512 are cut, leaving a patterned label 514. The sheet 506 is then removed, and the label 514 is adhered to the display component stock 520. A completed display strip 530 is illustrated in FIG. 12.

As an alternative to including an adhesive backing 502 on the label stock 500, the display component stock 520 could instead include an adhesive surface for receiving patterned labels 514. This embodiment provides a reduced thickness of the label stock 500 passing through the printer P.

In the above embodiments, game components are disclosed as in communication via cables. However, game components can be in communication by alternative methods. For example, game components can be in communication using remote transmitters and receivers, such as in an optical, infrared, or radio connection.

While the above games, display strips and methods are described with reference to exemplary embodiments, many modifications will be readily apparent to those skilled in the art, and the present disclosure is intended to cover variations thereof.

In the claims:

1. A method of playing a game, comprising:
applying at least one display strip to at least one player, wherein the display strip comprises a plurality of lights, and wherein the lights are capable of displaying images;
receiving input from at least one player;
providing output signals to the display strip; and
displaying images on the display strip.

2. The method of claim 1, wherein the step of providing output signals comprises:
providing output signals indicative of the player's status in the game.

3. The method of claim 2, wherein the step of displaying images comprises:
displaying the player's status in the game on the display strip.

4. The method of claim 3, wherein the display strip comprises a plurality of display strips and the at least one player comprises a plurality of players, and wherein the step of applying at least one display strip to at least one player comprises:
applying at least one display strip to each player.

5. The method of claim 4, wherein the step of displaying images comprises:
displaying each player's game status on that player's display strip.

6. The method of claim 1, wherein the step of receiving input from at least one player comprises:
receiving input from a game input device operated by the player.

7. The method of claim 6, wherein the step of providing output signals to the display strip comprises:
providing output signals from a game processor.

8. The method of claim 3, wherein the step of receiving input from at least one player comprises:
receiving input provided by a simulated weapon shot.

9. The method of claim 1, comprising:
emitting an audible sound from the display strip.

10. A game, comprising:
a processor;
at least one display strip in communication with the processor, wherein the display strip includes a plurality of lights, and a mounting structure capable of mounting the display strip on a player; and
a display in communication with the processor.

11. The game of claim 10, wherein the display strip comprises a plurality of display strips, the game further comprising:
a plurality of game input devices in communication with the processor, wherein the game input devices receive input from players.

12. The game of claim 11, wherein each game input device is associated with a display strip, and wherein each game input device is arranged to receive input from a specified player and the display strip associated with the game input device is arranged to display status information for the specified player.

13. The game of claim 12, wherein the plurality of display strips are in communication with the processor through the game input devices.

14. The game of claim 10, comprising:
at least one sensor, wherein the sensor is capable of sensing radiation from a simulated weapon firing and providing an output to the processor in response to the simulated weapon firing.

15. The game of claim 14, wherein the display strip comprises a plurality of display strips, and wherein the lights of each display strip are arranged to display a player's status in the game.

16. The game of claim 10, wherein the processor comprises:
a hand-held microprocessor capable of executing stored game instructions.

17. A method of making a display strip, comprising:
providing electronic component stock, wherein the electronic component stock comprises a plurality of lights;
providing label stock, the label stock having a printable surface;
printing an image on the label stock; and
securing the label stock to the electronic component stock.

18. The method of claim 17, comprising:
cutting the label stock so that a resulting shape of the label stock generally conforms with a shape of the electronic component stock.

19. The method of claim 17, wherein the step of providing label stock comprises:
providing label stock having window portions that allow light to be transmitted through the label stock.

20. The method of claim 17, wherein the step of securing the label stock comprises:
securing the label stock using an adhesive.

21. The method of claim 17, wherein the step of printing an image comprises:
creating an image using a graphics program; and
instructing a printer to print the image on the label stock.
